(19) United States
(12) Patent Application Publication
(10) Pub. No.: US 2026/0214621 A1
(43) Pub. Date: Jul. 23, 2026

(54) REDUCED-CAPABILITY UE CONFIGURED FOR DL PRS AND SRS COLLISION HANDLING

(71) Applicant: Intel Corporation, Santa Clara, CA (US)

(72) Inventors: Gang Xiong, Beaverton, OR (US); Debdeep Chatterjee, San Jose, CA (US); Yingyang Li, Beijing (CN)

(21) Appl. No.: 19/142,756

(22) PCT Filed: Dec. 4, 2023
(86) PCT No.: PCT/US2023/082260

§ 371 Date: Jun. 24, 2025

Related U.S. Application Data
(60) Provisional application No. 63/481,689, filed on Jan. 26, 2023.

(51) Int. Cl. H04W 64/00; H04L 5/00; H04L 5/16

(52) U.S. Cl. CPC H04W 64/00; H04L 5/0044; H04L 5/16

(57) ABSTRACT

A Reduced-Capacity User Equipment (RedCap UE) may decode configuration information received from a gN-odeB (gNB) to configure the RedCap UE for UL sounding reference signal (UL SRS) transmission for positioning with transmit frequency hopping. The RedCap UE may determine whether to drop the UL SRS transmission based on priority rules when any one or more symbols of the UL SRS transmission would collide with an uplink channel transmission including a switching time for switching to or from an active bandwidth part. When the UL SRS transmission is determined to be dropped, the RedCap UE may drop the one or more symbols of the UL SRS transmission that would collide and may transmit any symbols of the UL SRS transmission that do not collide with the uplink channel transmission. The RedCap UE may be a half-duplex (HD) frequency division duplex (FDD) RedCap UE and may perform transmit frequency hopping over a bandwidth that is larger than a maximum bandwidth of the RedCap UE.

### PRIORITY CLAIM

This application claims priority to United States Provisional Patent Application Ser. No. 63/481,689, filed Jan. 26, 2023 [reference number AF1588-Z] which is incorporated herein by reference in its entirety.

### TECHNICAL FIELD

Some embodiments relate to 3GPP (Third Generation Partnership Project) and fifth-generation (5G) networks including 5G new radio (NR) (5G-NR) networks. Some embodiments relate to sixth-generation (6G) networks.

### BACKGROUND

Mobile communications have evolved significantly from early voice systems to today's highly sophisticated integrated communication platform. With the increase in different types of devices communicating with various network devices, usage of 3 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

One issue with 5G-NR networks is collisions between signals for reduced capacity (RedCap) UEs.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2A illustrates a downlink positioning reference signal (DL PRS) with a higher priority in a PRS processing window outside the measurement gap, in accordance with some embodiments.

FIG. 2B illustrates a DL PRS with a higher priority than a physical uplink shared channel (PUSCH) in a PRS processing window outside the measurement gap, in accordance with some embodiments.

FIG. 2C illustrates collision handling for a sounding reference signal (SRS) for positioning with guard periods and a physical uplink control channel (PUCCH) with priority index 1, in accordance with some embodiments.

FIG. 3 illustrates a functional block diagram of a wireless communication device.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments disclosed herein are directed to a Reduced-Capacity User Equipment (RedCap UE). In these embodiments, the RedCap UE may decode configuration information received from a gNodeB (gNB) to configure the RedCap UE for UL sounding reference signal (UL SRS) transmission for positioning with transmit frequency hopping. The RedCap UE may determine whether to drop the UL SRS transmission based on priority rules when any one or more symbols of the UL SRS transmission would collide (i.e., overlap) with an uplink channel transmission including a switching time for switching to or from an active bandwidth part. When the UL SRS transmission is determined to be dropped, the RedCap UE may drop the one or more symbols of the UL SRS transmission that would collide with the uplink channel transmission and may transmit any symbols of the UL SRS transmission that do not collide with the uplink channel transmission. The RedCap UE may be a half-duplex (HD) frequency division duplex (FDD) RedCap UE and may perform transmit frequency hopping over a bandwidth that is larger than a maximum bandwidth of the RedCap UE. These embodiments, as well as others, are described below.

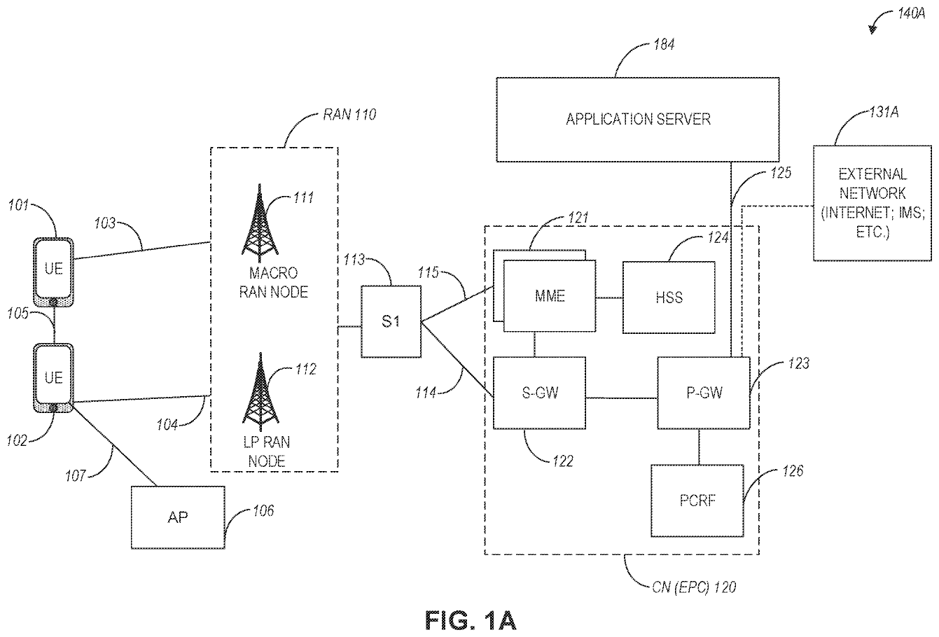

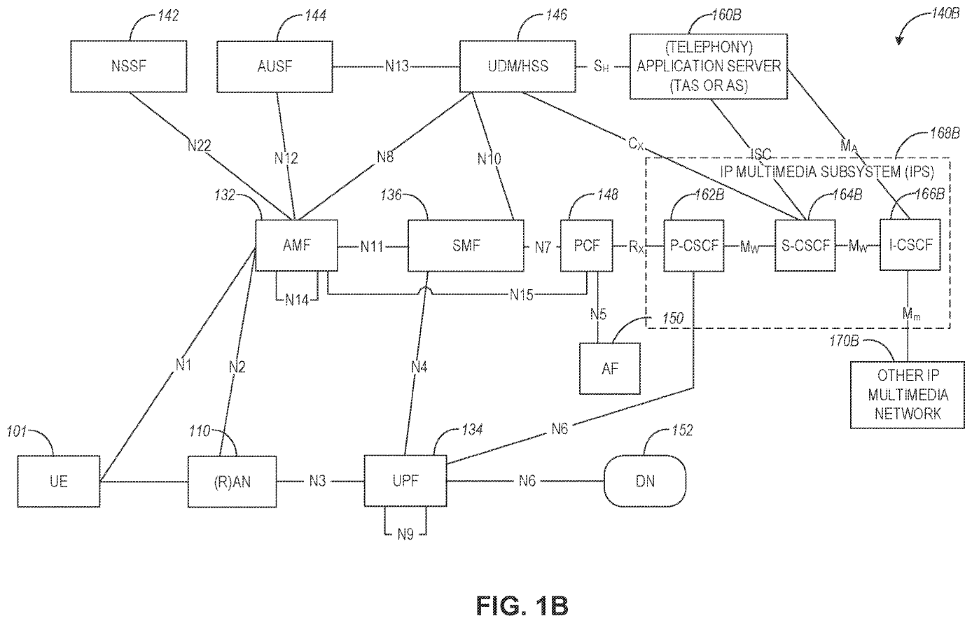

FIG. 1A illustrates an architecture of a network in accordance with some embodiments. The network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UE 101 and UE 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHz, and further frequencies and Spectrum Access System (SAS) in 3.55-3.7 GHZ and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UE 101 and UE 102 can comprise an Internet-of-Things (IoT) UE or a Cellular IoT (CIoT) UE, which can comprise a network access layer designed for low-power IoT applications utilizing short-lived UE connections. In some embodiments, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data.

An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UE 101 and UE 102 can include enhanced MTC (eMTC) UEs or further enhanced MTC (FeMTC) UEs.

The UE 101 and UE 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the RAN nodes 111 and 112 can be transmission/reception points (TRPs). In instances when the RAN nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node, and one or more RAN nodes for providing femtocells or picocells (e.g., cells having smaller coverage areas, smaller user capacity, or higher bandwidth compared to macrocells), e.g., low power (LP) RAN node.

Any of the RAN nodes 111 and 112 can terminate the air interface protocol and can be the first point of contact for the UE 101 and UE 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the RAN nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities'handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the core network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. In these embodiments, the RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B.

The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs 134, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Reduced Capacity UEs (RedCap UEs) have been introduced for 5G NR and have different requirements than standard or full-capacity NR UEs for operating in a 5G NR system. These are described below:
Maximum device bandwidth: A baseline NR UE is required to support 100 MHz in frequency range 1 (FR1), and 200 MHz in FR2, for transmission and reception. For RedCap, these requirements are reduced to 20 MHz and 100 MHz, respectively. Such bandwidth reductions however still allow all the physical channels and signals specified for initial acquisition to be readily reusable for RedCap UEs, therefore minimizing the impact on network and device deployment when introducing RedCap to support the new use cases.
Minimum number of device receive branches: The number of receive branches is related to the number of receive antennas. Reducing the number of receive branches therefore results in a reduction in the number of receive antennas and cost saving. The requirements on the minimum number of receive branches depends on frequency bands. Some frequency bands (most of the FR1 frequency-division duplex (FDD) bands, a handful of FR1 time-division duplex (TDD) bands, and all FR2 bands) require a baseline NR UE to be equipped with two receive branches, whereas some other frequency bands, mostly in the FR1 TDD bands, require the device to be equipped with four receive branches.

For the bands where a baseline NR UE is required to be equipped with a minimum of two receive branches, a RedCap UE is only required to have one receive branch. For the bands where a baseline NR UE is required to be equipped with a minimum of four receive branches, it is yet to be decided whether a RedCap UE is required to have one or two receive branches.
Maximum number of downlink MIMO layers: The maximum number of downlink MIMO layers for a RedCap UE is the same as the number of receive branches it supports. This is a reduction compared to the requirements for a baseline device.
Maximum downlink modulation order: A baseline NR UE is required to support 256QAM in the downlink in FR1. For a RedCap UE, the support of downlink 256QAM is optional. For FR1 uplink and FR2, both downlink and uplink, a RedCap UE is required to support 64QAM, same as the requirement for a baseline device.
Duplex operation: Regarding duplex operations, the only relaxation is for operations in FDD bands. A baseline NR UE is required to support a full duplex (FD) operation in an FDD band, i.e., transmitting and receiving on different frequencies at the same time. A typical full-duplex device incorporates a duplex filter to isolate the interference between the device's transmit and receive paths. In practice, the same device may need to support multiple FDD bands; therefore, multiple duplex filters may be needed to support the FD-FDD operation.

For a RedCap UE, the support of FD-FDD is optional, i.e., it is not required to receive in the downlink frequency while transmitting in the uplink frequency, and vice versa. Such a duplex operation is referred to as half duplex FDD (HD-FDD). HD-FDD obviates the need for duplex filters. Instead, a switch can be used to select the transmitter or receive to connect to the antenna. As a switch is less expensive than multiple duplexers, cost savings are achieved.

Furthermore, a RedCap UE is expected to operate in a single band at a time and will not support carrier aggregation and dual connectivity.

5G NR systems support highly precise positioning in the vertical and horizontal dimensions, which relies on timing-based, angle-based, power-based or hybrid techniques to estimate the user location in the network. In particular, the following RAT dependent positioning techniques were introduced, which can meet the positioning requirements for various use cases, e.g., indoor, outdoor, Industrial internet of thing (IoT), etc.
Downlink time difference of arrival (DL-TDOA)
Uplink time difference of arrival (UL-TDOA)
Downlink angle of departure (DL-AoD)
Uplink angle of arrival (UL AoA)
Multi-cell round trip time (multi-RTT).
NR enhanced cell ID (E-CID)

With wide bandwidth for positioning signal and beamforming capability in mm Wave frequency band, higher positioning accuracy can be achieved by RAT dependent positioning techniques. Note that in Rel-16, downlink positioning reference signal (DL PRS) and uplink sounding reference signal (UL SRS) for positioning were introduced as enabler to achieve target performance characteristics.

In Rel-17, a class of Reduced Capability (RedCap) NR User Equipment (UE) is expected to be defined that can be served using the currently specified 5G NR framework with necessary adaptations and enhancements to limit device complexity and power consumption while minimizing any adverse impact to network resource utilization, system spectral efficiency, and operation efficiency. In particular, RedCap UEs support a maximum UE BW of 20 MHz in frequency range 1 (FR1) bands and a maximum UE BW of 100 MHz in FR 2 bands. Further, for frequency division multiplexing (FDD) bands, a further complexity reduction feature is support of half duplex-FDD (HD-FDD) that allows to replace a duplexer with a switch, that helps reduce cost as well as insertion loss due to the duplexer.

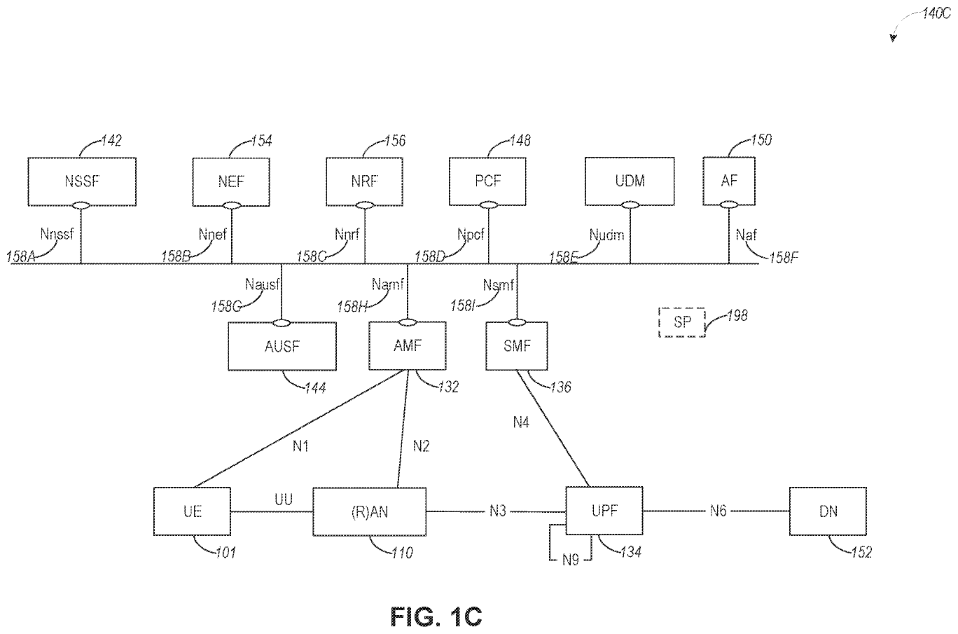

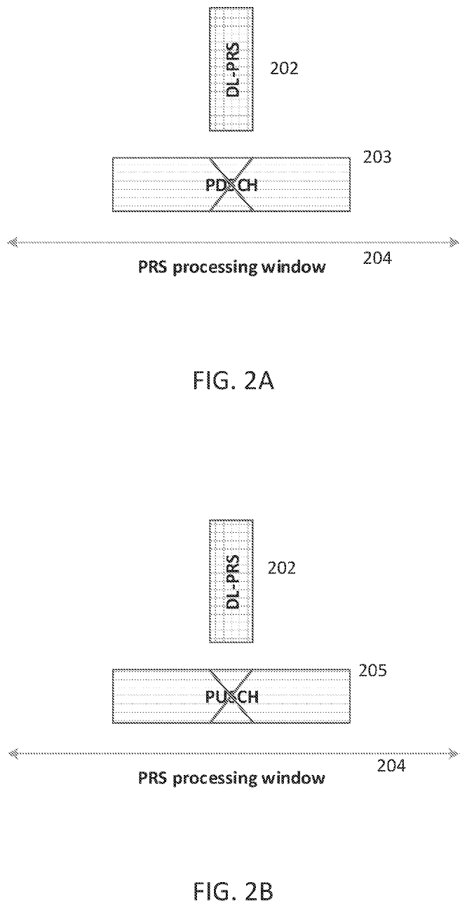

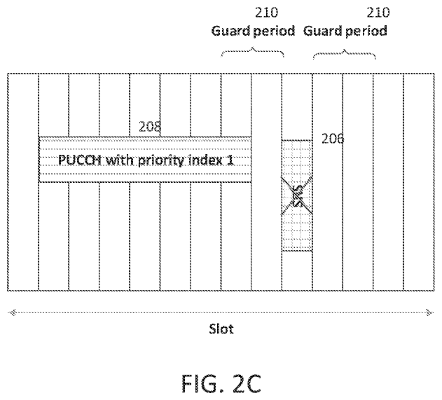

Further, different priority orders were defined for DL positioning reference signal (DL PRS) within a PRS processing window outside the measurement gap. In particular, depending on the configured priority, DL PRS may have higher priority or lower priority than other DL channels and signals within the PRS processing window. FIG. 2A illustrates one example of DL PRS with higher priority in a PRS processing window 204 outside the measurement gap. In the example, when UE determines that DL PRS 202 has higher priority than the PDSCH 203, the PDSCH 203 is not expected to be received by the UE within the PRS processing window.

Note that a HD-FDD RedCap UE will not be able to receive and transmit simultaneously in the DL and UL carriers. For UL sounding reference signal (SRS) for positioning, it would be necessary to address scenarios involving time-overlaps between DL PRS/SRS for positioning and other DL/UL signals and channels. In this case, certain mechanisms may need to be defined for handling collision between DL PRS and UL channels/signals within a PRS processing window outside the measurement gap for a RedCap HD-FDD UE.

Disclosed here are systems and methods on collision handling of DL PRS and SRS for positioning for RedCap UE. Some of these embodiments address collision handling between DL PRS and UL signals/channels for RedCap HD-FDD UEs. Some of these embodiments address collision handling between SRS and other signals/channels for RedCap UEs. These embodiments are described in more detail below.

### Collision Handling Between DL PRS and UL Signals/Channels for RedCap HD-FDD UEs

As mentioned above, in Rel-17, different priority orders were defined for DL positioning reference signal (DL PRS) within a PRS processing window outside the measurement gap. In particular, depending on the configured priority, DL PRS may have higher priority or lower priority than other DL channels and signals within the PRS processing window.

Further, a HD-FDD RedCap UE will not be able to receive and transmit simultaneously in the DL and UL carriers. For UL sounding reference signal (SRS) for positioning, it would be necessary to address scenarios involving time-overlaps between DL PRS/SRS for positioning and other DL/UL signals and channels. In this case, certain mechanisms may need to be defined for handling collision between DL PRS and UL channels/signals within a PRS processing window outside the measurement gap for a RedCap HD-FDD UE.

Embodiments of collision handling between DL PRS and UL signals/channels for RedCap HD-FDD UEs are provided as follows:

In one embodiment, for RedCap HD-FDD UEs, when DL PRS overlaps with UL signals and channels within a configured PRS processing window outside the measurement gap, the UE determines the priority of DL PRS in accordance with a parameter, which can be configured by radio resource control (RRC) signalling.

In one option, same parameter “priority” for handling collision between DL PRS and other DL channels and signals can be reused for handling collision between DL PRS and UL channels and signals for RedCap HD-FDD UEs within a configured PRS processing window outside the measurement gap. In a further example, new states of the “priority” parameter to indicate relative priority of DL PRS reception and transmission of UL channels or signals may be defined by extending the bit-width of the “priority” parameter. Alternatively, the existing three defined states of the “priority” parameter may be reused to also indicate the relative priorities between DL PRS reception and transmission of UL channels or signals.

In another option, separate parameter from handling collision between DL PRS and other DL channels and signals can be configured for handling collision between DL PRS and UL channels and signals for RedCap HD-FDD UEs within a configured PRS processing window outside the measurement gap.

In another embodiment, depending on the priority configuration for DL PRS, the following states may be defined as the priority of DL PRS when overlapping with UL channels and signals for RedCap HD-FDD UEs within a configured PRS processing window outside the measurement gap:
State 1: DL PRS is higher priority than all the UL signals and channels
State 2: DL PRS is lower priority than PRACH, MsgA PUSCH, PUCCH with a priority index 1 and PUSCH with a priority index 1, and is higher priority than other UL signals and channels.
State 3: DL PRS is lower priority than all the UL signals and channels.

In another option, the following states may be defined as the priority of DL PRS when overlapping with UL channels and signals for RedCap HD-FDD UEs within a configured PRS processing window outside the measurement gap:
State 1: DL PRS is higher priority than all the UL signals and channels
State 2: DL PRS is lower priority than PRACH, MsgA PUSCH, PUCCH carrying dynamic HARQ-ACK with a priority index 1 and dynamically scheduled PUSCH with a priority index 1, and is higher priority than other UL signals and channels.
State 3: DL PRS is lower priority than all the UL signals and channels.

In another option, DL PRS may be lower priority than PRACH and MsgA PUSCH. Further, the following states may be defined as the priority of DL PRS when overlapping with other UL channels and signals for RedCap HD-FDD UEs within a configured PRS processing window outside the measurement gap:
State 1: DL PRS is higher priority than all the UL signals and channels, except PRACH and MsgA PUSCH
State 2: DL PRS is lower priority than PUCCH with a priority index 1 and PUSCH with a priority index 1, and is higher priority than other UL signals and channels, except PRACH and MsgA PUSCH.
State 3: DL PRS is lower priority than all the UL signals and channels.

In another option, it may be up to UE implementation to handle the case that DL PRS that is overlapped with PRACH and MsgA PUSCH.

Further, the following states may be defined as the priority of DL PRS when overlapping with other UL channels and signals for RedCap HD-FDD UEs within a configured PRS processing window outside the measurement gap:
State 1: DL PRS is higher priority than all the UL signals and channels, except PRACH and MsgA PUSCH
State 2: DL PRS is lower priority than PUCCH with a priority index 1 and PUSCH with a priority index 1, and is higher priority than other UL signals and channels, except PRACH and MsgA PUSCH.
State 3: DL PRS is lower priority than all the UL signals and channels, except PRACH and MsgA PUSCH.

In another option, the following states may be defined as the priority of DL PRS when overlapping with UL channels and signals, other than PRACH and MsgA PUSCH for RedCap HD-FDD UEs within a configured PRS processing window outside the measurement gap:
State 1: DL PRS is higher priority than all the UL signals and channels, except PRACH and MsgA PUSCH
State 2: DL PRS is lower priority than PUCCH with a priority index 1 and PUSCH with a priority index 1, and is higher priority than other UL signals and channels, except PRACH and MsgA PUSCH.
State 3: DL PRS is lower priority than all the UL signals and channels, except PRACH and MsgA PUSCH.

For PRACH and MsgA PUSCH, different handling may be defined for the above different states. In one example, for state 1 and 2, it may be up to UE implementation to handle the case that DL PRS that is overlapped with PRACH and MsgA PUSCH. For State 3, DL PRS is lower priority than all the UL signals and channels.

In one example, the priority between DL PRS and UL channels and signals for RedCap HD-FDD UEs can be defined by updating the existing specifications for non-RedCap UEs as follows:
For the case of reduced capability half-duplex UE in paired spectrum, for receiving the DL PRS outside the measurement gap and within the DL PRS processing window, the priority between DL PRS and SSB is defined in 3GPP TS 38.133 and the UE determines the DL PRS priority as indicated by higher layer parameter priority subject to UE capability or as implied by UE capability, except for SSB:
with value ‘st1’ where the DL PRS is higher priority than all the DL and UL signals and channels, or
with value ‘st2’ where the DL PRS is lower priority than PDCCH and the PDSCH scheduled by DCI formats 1_1 or 1_2 with the priority indicator field in the corresponding DCI format set to 1, or than PUCCH with a priority index 1 and PUSCH with a priority index 1, and is higher priority than other DL and UL signals and channels, or
with value ‘st3’ where the DL PRS is lower priority than all the DL or UL signals and channels.

In another embodiment, when a RedCap HD-FDD UE is expected to measure the DL PRS outside the measurement gap in a configured PRS processing window, depending on UE capability and configuration, and if the DL PRS is determined to be higher priority than the UL signals and channels inside the PRS processing window, those UL signals and channels are not expected to be transmitted by the UE.

FIG. 2B illustrates one example of DL PRS with higher priority than PUSCH in a PRS processing window outside the measurement gap. In the example, UE is configured with “st1”, where DL PRS 202 is higher priority than all the UL signals and channels within the configured PRS processing window 204. In this case, the PUSCH 205 is dropped and not transmitted by the UE.

In another embodiment, when a RedCap HD-FDD UE is expected to measure the DL PRS outside the measurement gap in a configured PRS processing window, depending on UE capability and configuration, if the DL PRS is determined to be higher priority than the UL signals and channels inside the PRS processing window, those UL signals and channels from the impacted serving cells are not expected to be transmitted by the UE on the overlapped symbols with the DL PRS, where impacted serving cells refer to the serving cell on which the DL-PPW-PreConfig is configured for a frequency range 1 band, and the serving cell in the same band as the DL PRS for a frequency range 2 band.

In another embodiment, when a RedCap HD-FDD UE is expected to measure the DL PRS outside the measurement gap in a configured PRS processing window, depending on UE capability and configuration, if the DL PRS is determined to be higher priority than the UL signals and channels inside the PRS processing window, those UL signals and channels are not expected to be transmitted by the UE on the overlapped symbols with the DL PRS.

In another embodiment, when a RedCap HD-FDD UE is expected to measure the DL PRS outside the measurement gap in a configured PRS processing window, depending on UE capability and configuration, and if the DL PRS is determined to be higher priority than the PUSCH and PUCCH inside the PRS processing window, PUSCH and PUCCH are not expected to be transmitted by the UE.

In addition, if the DL PRS is determined to be higher priority than the SRS inside the PRS processing window, SRS are not expected to be transmitted by the UE on the overlapped symbols with the DL PRS.

In another embodiment, when a RedCap HD-FDD UE has an activated PRS processing window, depending on UE capability and configuration, and the UE determines the presence of other UL signals and channels of higher priority than the DL PRS in the PRS processing window no later than N2 symbols for the subcarrier spacing μ of the DL PRS or minimum subcarrier spacing between DL PRS and UL signals and channels, before the first symbol of the PRS processing window, the UE is expected to transmit the other UL signals and channels and may not be expected to receive DL PRS within the PRS processing window.

In another embodiment, when a RedCap HD-FDD UE has an activated PRS processing window, depending on UE capability and configuration, and the UE determines the presence of other UL signals and channels of higher priority than the DL PRS on a symbol configured with the DL PRS no later than N2 symbols for the subcarrier spacing μ of the DL PRS or minimum subcarrier spacing between DL PRS and UL signals and channels, before the DL PRS symbol, the UE is expected to transmit the other UL signals and channels and may not be expected to receive DL PRS in the affected symbol.

In another embodiment, when a RedCap HD-FDD UE has an activated PRS processing window, depending on UE capability and configuration, and the UE determines the presence of other UL signals and channels of higher priority than the DL PRS in the PRS processing window later than N2 symbols for the subcarrier spacing μ of the DL PRS or minimum subcarrier spacing between DL PRS and UL signals and channels, before the first symbol of the PRS processing window, the UE is not required to transmit the other UL signals and channels and may receive the DL PRS and consider the DL PRS as higher priority in the PRS processing window. Here, N2 is defined per UE processing capability 1 as in 3GPP TS 38.214.

In another embodiment, when a RedCap HD-FDD UE has an activated PRS processing window, depending on UE capability and configuration, and the UE determines the presence of other UL signals and channels of higher priority than the DL PRS on a symbol configured with the DL PRS later than N2 symbols for the subcarrier spacing μ of the DL PRS or minimum subcarrier spacing between DL PRS and UL signals and channels, before the DL PRS symbols, the UE is not required to transmit the other UL signals and channels and may receive the DL PRS symbol and consider the DL PRS as higher priority in that symbol. Here, N2 is defined per UE processing capability 1 as in 3GPP TS 38.214.

In another embodiment, for DL PRS with frequency hopping for a RedCap UE, the switching time or guard time between two DL PRS transmissions or receptions, the UE may apply the same priority rules as defined in Clause 11.1 and Clause 17 in TS 38.213 and Clause 5.1.6.5 in TS 38.214 during the switching time or guard period as if DL PRS is configured.

In another embodiment, RedCap UE in RRC_INACTIVE mode is expected to prioritize the reception of any other DL signals and DL channels than the reception of DL PRS including any switching time or guard time for DL PRS with frequency hopping.

### Collision Handling Between SRS and Other Signals/Channels for RedCap UEs

Embodiments of handling between SRS and other signals/channels for RedCap UEs are provided as follows:

In one embodiment, for SRS for positioning with Tx frequency hopping for a RedCap UE, the switching period or guard time between two SRS transmissions or for the associated SRS transmission, the UE applies the same priority rules as defined in Clause 11.1 and Clause 17 in TS38.213 and Clause 6.2.1 in TS 38.214 during the switching time or guard period as if SRS is configured or as for the associated SRS transmission.

In one example, for a RedCap UE, for PUCCH and SRS on the same carrier, a UE may not transmit SRS for positioning when semi-persistent or periodic SRS including a switching time for switching to or from an active bandwidth part is configured overlapping with the symbol(s) with PUCCH carrying only CSI report(s), or only L1-RSRP report(s), or only L1-SINR report(s).

In another example, a RedCap UE may not transmit SRS when semi-persistent or periodic SRS is configured or aperiodic SRS is triggered to be transmitted including a switching time for switching to or from an active bandwidth part overlapping with the symbol(s) with PUCCH carrying HARQ-ACK, link recovery request and/or SR.

In another example, for a RedCap UE, PUCCH may not be transmitted when aperiodic SRS is triggered to be transmitted including a switching time for switching to or from an active bandwidth part overlapping with a symbol with PUCCH carrying semi-persistent/periodic CSI report(s) or semi-persistent/periodic L1-RSRP report(s) only, or only L1-SINR report(s).

In another example, for a RedCap UE, if a PUSCH transmission with a priority index 1 or a PUCCH transmission with a priority index 1 would overlap in time with an SRS transmission including a switching time for switching to or from an active bandwidth part on a serving cell, the UE may not transmit the SRS in the overlapping symbol(s). In some aspects, switching period may be defined before and/or after the associated SRS transmission(s) with frequency hopping. FIG. 2C illustrates one example of collision handling for SRS for positioning with guard period and PUCCH with priority index 1. In the example, a guard period 210 before and after SRS transmission 206 is defined. Further, the SRS transmission 206 including guard period 210 overlaps with the PUCCH 208 with priority index 1. Based on the aforementioned rule, the SRS transmission 206 may be cancelled.

In some embodiments, for SRS for positioning with Tx frequency hopping for a RedCap UE, the switching period or guard time between two SRS transmissions or for the associated SRS transmission, the UE applies the same priority rules as defined in Clause 11.1 and Clause 17 in TS38.213 and Clause 6.2.1 in TS 38.214 during the switching time or guard period as if SRS is configured or as for the associated SRS transmission.

In these embodiments, the UL SRS may provide channel state information to the gNB for use by the gNB in estimating uplink channel quality for example, for frequency-dependent scheduling and link adaptation. In these embodiments, the DL PRS may be used by the UE to measure a time difference of arrival (TDOA) and report the TDOA to the network for trilateration-based positioning calculations. In some embodiments, the UL SRS measurements at the gNB may provide information about which beams experience the best uplink quality which may be used by the gNB to determine which downlink beams provide the highest quality for transmitting DL PRS to the UE for most accurate positioning measurements, although the scope of the embodiment is not limited in this respect. High-quality beam alignment is important for both positioning accuracy as well as reliable data transmission.

Some embodiments are directed to an apparatus of a reduced-capacity User Equipment (RedCap UE) comprising processing circuitry and memory. In these embodiments, the RedCap UE may decode configuration information received from a gNodeB (gNB) to configure the RedCap UE for UL sounding reference signal (UL SRS) transmission for positioning with transmit frequency hopping. In these embodiments, the RedCap UE may determine whether to drop the UL SRS based on priority rules when any one or more symbols of the UL SRS transmission would collide (i.e., overlap) with an uplink channel transmission including a switching time for switching to or from an active bandwidth part. In these embodiments, when the UL SRS transmission is determined to be dropped, the RedCap UE may drop only the one or more symbols of the UL SRS that would collide with the uplink channel transmission including colliding with a switching time for switching to or from an active bandwidth part and may transmit any symbols of the UL SRS that do not collide with the uplink channel transmission. In these embodiments, if the SRS symbol(s), including the switching time to switch to or from the active bandwidth part, collides with an uplink channel transmission (i.e., a PUSCH or PUCCH) including the switching time to or from the active bandwidth part, and if the RedCap UE determines that the SRS is to be dropped, the colliding SRS symbol(s) are dropped, although the scope of the embodiments is not limited in this respect.

In some embodiments, the RedCap UE may be a half-duplex (HD) frequency division duplex (FDD) RedCap UE. In these embodiments, when the RedCap UE is configured for the UL SRS transmission for positioning with transmit frequency hopping, the processing circuitry may configure the RedCap UE to perform frequency hopping over a bandwidth that is larger than a maximum bandwidth of the RedCap UE. For example, for a RedCap UE that has a maximum bandwidth of 20 MHz, the RedCap UE may perform frequency hopping by transmitting an SRS across multiple 20 MHz bandwidths to meet a 100 MHz bandwidth.

In some embodiments, when any one or more symbols of the UL SRS transmission would collide with the uplink channel transmission including the switching time for switching to or from the active bandwidth part, and when the uplink channel transmission comprises a physical uplink control channel (PUCCH) with a priority index of one or a physical uplink shared channel (PUSCH) with a priority index of one, the RedCap UE may drop the one or more symbols of the UL SRS that would collide with the uplink channel transmission including a switching time for switching to or from an active bandwidth part and may transmit any symbols of the UL SRS that do not collide with the uplink channel transmission. In these embodiments, the PUCCH with priority index 1 and the PUSCH with priority index 1 have a higher priority than the UL SRS for positioning. An example of collision handling for SRS for positioning with guard period and PUCCH with priority index 1 is illustrated in FIG. 2C.

In some embodiments, when the UL SRS comprises an aperiodic SRS and when any one or more symbols of the aperiodic SRS transmission would collide with the uplink channel transmission including the switching time for switching to or from the active bandwidth part, the RedCap UE may drop the entire uplink channel transmission when the uplink channel comprises a physical uplink control channel (PUCCH) carrying semi-persistent or periodic channel state information (CSI) report(s), carrying only one or more semi-persistent or periodic Layer one Reference Signal Received Power (L1-RSRP) reports, or carrying only one or more Layer one Signal to Interference and Noise Ratio (L1-SINR) reports.

In some embodiments, when the UL SRS comprises a semi-persistent or periodic SRS transmission or an aperiodic SRS transmission that is triggered to be transmitted and when any one or more symbols of the UL SRS transmission would collide with the uplink channel transmission including the switching time for switching to or from the active bandwidth part, the RedCap UE may drop only the one or more symbols of the UL SRS that would collide with the uplink channel transmission including a switching time for switching to or from an active bandwidth part when the UL channel comprises a physical uplink control channel (PUCCH) carrying Hybrid Automatic Repeat reQuest (HARQ-ACK) information, a link recovery request or a scheduling request (SR).

In some embodiments, the RedCap UE may decode the configuration information to determine a priority parameter for measurement of a downlink positioning reference signal (DL PRS) within a configured PRS processing window outside a measurement gap. In these embodiments, the priority parameter may indicate a priority of the DL PRS relative to uplink (UL) signals or channels to be transmitted by the RedCap UE within the configured PRS processing window. In these embodiments, when any of the UL signals or channels to be transmitted by the RedCap UE within the configured PRS processing window are determined to overlap with the DL PRS, and when the priority parameter indicates that the DL PRS has a higher priority than a priority of the overlapping UL signal or channel (that is determined to overlap with the DL PRS), the processing circuitry is to configure the RedCap UE to receive the DL PRS outside the measurement gap during the configured PRS processing window, and refrain from transmission of the overlapping UL signal or channel within the configured PRS processing window. In these embodiments, collision handling between DL PRS and UL signals or channels for HD-FDD RedCap UEs is addressed.

In some embodiments, the RedCap UE may be configured to decode a medium access control (MAC) control element (MAC-CE) to activate the configured PRS processing window. In these embodiments, when any of the UL signals or channels to be transmitted by the RedCap UE within the configured PRS processing window are determined to overlap with the DL PRS when the priority parameter indicates that the DL PRS has a priority that is not higher than the priority of the overlapping UL signal or channel, the processing circuitry is to configure the RedCap UE to transmit the overlapping UL signal or channel during the configured PRS processing window, and refrain from receiving the DL PRS.

In some embodiments, when the UL signal or channel comprises a physical uplink shared channel (PUSCH) scheduled to be transmitted by the RedCap UE within the configured PRS processing window, and when any symbol of the UL channel to be transmitted by the RedCap UE is determined to overlap with the DL PRS, and when the priority parameter indicates that the DL PRS has a higher priority than a priority of the UL channel, the processing circuitry is to configure the RedCap UE to receive the DL PRS outside the measurement gap during the configured PRS processing window and refrain from transmission the overlapping symbols of the UL channel.

In some embodiments, the RedCap UE may refrain from transmitting all symbols of the UL channel including the symbols that do not overlap with the DL PRS, although the scope of the embodiments is not limited in this respect. An example of a DL PRS with higher priority than PUSCH in a PRS processing window outside the measurement gap is illustrated in FIG. 2B.

In some embodiments, the RedCap UE may be configured to decode a radio-resource control (RRC) signalling comprising an indication of priority corresponding to the priority parameter. In these embodiments, the RRC signalling may comprise a first indication of priority for the DL PRS with respect to the UL SRS, a second indication of priority for the DL PRS with respect to one or more other uplink channels or signals, and a third indication of priority for the DL PRS with respect to one or more DL channels. In some of these embodiments, the RRC signalling may comprise an RRC information element (IE). In some embodiments, the priority parameter may be a priority order, a priority index, a priority state or other priority indication used to convey relative priority. In some embodiments, the priority parameter for handling collisions between DL PRS and DL channels may be reused for handling collisions between the DL PRS and UL signals/channels, although the scope of the embodiments is not limited in this respect.

In some embodiments, the RedCap UE may decode configuration information received from the gNB for the configured PRS processing window. In some of these embodiments, the configuration information may be received in a DL-PPW-PreConfig for a serving cell. In these embodiments, the configuration information for the configured PRS processing window may comprise a PRS periodicity and PRS occasion length. In these embodiments, when the DL PRS is received during the configured PRS processing window, the RedCap UE may process the received DL PRS during the configured PRS processing window for location determination. In these embodiments, the PRS processing window may refer to the time period over which the RedCap UE processes received PRS signals to determine its location. The network signals the PRS periodicity and PRS occasion length as part of the PRS configuration. The start time of the PRS window may be indicated relative to the SS/PBCH block transmission period.

In some embodiments, when the RedCap UE is configured with a measurement gap for the DL PRS measurement and is not configured to measure the DL PRS during the configured PRS processing window, the processing circuitry is configured to receive positioning reference signals (PRS) during the configured measurement gap. In these embodiments, the RedCap UE is able to measure PRS during a measurement gap as well as outside a measurement gap.

In some embodiments, the RedCap UE may be configured to support a maximum bandwidth of 20 MHz in frequency range one (FR1) and support a maximum bandwidth of 100 MHz in frequency range 2 (FR2).

Some embodiments are directed to a non-transitory computer-readable storage medium that stores instructions for execution by processing circuitry of a reduced-capacity User Equipment (RedCap UE). In these embodiments, the processing circuitry may decode configuration information received from a gNodeB (gNB) to configure the RedCap UE for UL sounding reference signal (UL SRS) transmission for positioning with transmit frequency hopping. In these embodiments, the processing circuitry may determine whether to drop the UL SRS based on priority rules when any one or more symbols of the UL SRS transmission would collide (i.e., overlap) with an uplink channel transmission including a switching time for switching to or from an active bandwidth part. In these embodiments, when the UL SRS transmission is determined to be dropped, the processing circuitry is to drop only the one or more symbols of the UL SRS that would collide with the uplink channel transmission and to transmit any symbols of the UL SRS that do not collide with the uplink channel transmission.

Some embodiments are directed to an apparatus of a gNodeB (gNB) configured for operation in a fifth-generation new radio (5G NR) network. In these embodiments, the gNB may encode configuration information for transmission to a reduced-capacity User Equipment (RedCap UE) to configure the RedCap UE for UL sounding reference signal (UL SRS) transmission for positioning with transmit frequency hopping. In these embodiments, the gNB may determine whether the RedCap UE will determine to drop the UL SRS based on priority rules when any one or more symbols of the UL SRS transmission would collide (i.e., overlap) with an uplink channel transmission including a switching time for switching to or from an active bandwidth part. In these embodiments, when the UL SRS transmission is determined to be dropped by the RedCap UE, the processing circuitry is configured to decode only symbols of the UL SRS from the RedCap UE that do not collide with the uplink channel transmission. In these embodiments, the gNB does not expect to receive the one or more symbols of the UL SRS that would collide with the uplink channel transmission as they were dropped by the RedCap UE.

In some embodiments, the gNB may encode the configuration information to include a priority parameter for measurement of a downlink positioning reference signal (DL PRS) within a configured PRS processing window outside a measurement gap. In these embodiments, the priority parameter may indicate a priority of the DL PRS relative to uplink (UL) signals or channels to be transmitted by the RedCap UE within the configured PRS processing window. In these embodiments, when any of the UL signals or channels to be transmitted by the RedCap UE within the configured PRS processing window are determined to overlap with the DL PRS, and when the priority parameter indicates that the DL PRS has a higher priority than a priority of the overlapping UL signal or channel (that is determined to overlap with the DL PRS), the gNB is not expected to receive the overlapping UL signal or channel within the configured PRS processing window from the RedCap UE.

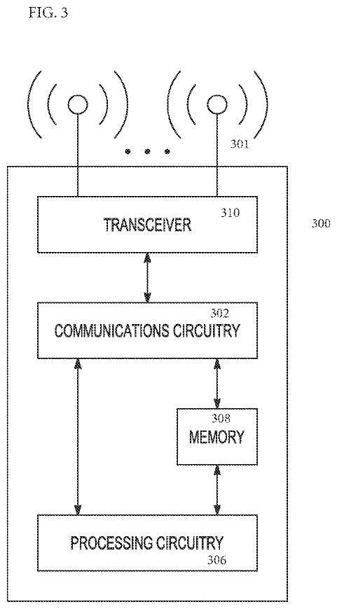

FIG. 3 illustrates a functional block diagram of a wireless communication device, in accordance with some embodiments. Wireless communication device 300 may be suitable for use as a UE or gNB configured for operation in a 5G NR or 6G network.

The wireless communication device 300 may include communications circuitry 302 and a transceiver 310 for transmitting and receiving signals to and from other communication devices using one or more antennas 301. The communications circuitry 302 may include circuitry that can operate the physical layer (PHY) communications and/or medium access control (MAC) communications for controlling access to the wireless medium, and/or any other communications layers for transmitting and receiving signals. The wireless communication device 300 may also include processing circuitry 306 and memory 308 arranged to perform the operations described herein. In some embodiments, the communications circuitry 302 and the processing circuitry 306 may be configured to perform operations detailed in the above figures, diagrams, and flows.

In accordance with some embodiments, the communications circuitry 302 may be arranged to contend for a wireless medium and configure frames or packets for communicating over the wireless medium. The communications circuitry 302 may be arranged to transmit and receive signals. The communications circuitry 302 may also include circuitry for modulation/demodulation, upconversion/downconversion, filtering, amplification, etc. In some embodiments, the processing circuitry 306 of the wireless communication device 300 may include one or more processors. In other embodiments, two or more antennas 301 may be coupled to the communications circuitry 302 arranged for sending and receiving signals. The memory 308 may store information for configuring the processing circuitry 306 to perform operations for configuring and transmitting message frames and performing the various operations described herein. The memory 308 may include any type of memory, including non-transitory memory, for storing information in a form readable by a machine (e.g., a computer). For example, the memory 308 may include a computer-readable storage device, read-only memory (ROM), random-access memory (RAM), magnetic disk storage media, optical storage media, flash-memory devices and other storage devices and media.

In some embodiments, the wireless communication device 300 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 300 may include one or more antennas 301. The antennas 301 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 300 may include one or more of a keyboard, a display, a non-volatile memory port, multiple antennas, a graphics processor, an application processor, speakers, and other mobile device elements. The display may be an LCD screen including a touch screen.

Although the wireless communication device 300 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 300 may refer to one or more processes operating on one or more processing elements.

### EXAMPLES

Example 1: A system and method of wireless communication for a fifth generation (5G) or new radio (NR) system: Configured, by gNodeB, a state parameter for a downlink positioning reference signal (DL PRS) priority for a reduced capability (RedCap) half duplex Frequency Division Duplex (HD-FDD) UEs; Determined, by UE, the DL PRS priority when the DL PRS overlaps with uplink signals and channels within a configured PRS processing window outside the measurement gap.

Example 2: The method of example 1, wherein same parameter “priority” for handling collision between DL PRS and other DL channels and signals can be reused for handling collision between DL PRS and UL channels and signals for RedCap HD-FDD UEs within a configured PRS processing window outside the measurement gap.

Example 3: The method of example 1, wherein the following states are configured: State 1: DL PRS is higher priority than all the UL signals and channels; State 2: DL PRS is lower priority than PRACH, MsgA PUSCH, PUCCH with a priority index 1 and PUSCH with a priority index 1, and is higher priority than other UL signals and channels; State 3: DL PRS is lower priority than all the UL signals and channels

Example 4: The method of example 1, wherein the following states are configured: State 1: DL PRS is higher priority than all the UL signals and channels; State 2: DL PRS is lower priority than PRACH, MsgA PUSCH, PUCCH carrying dynamic HARQ-ACK with a priority index 1 and dynamically scheduled PUSCH with a priority index 1, and is higher priority than other UL signals and channels; State 3: DL PRS is lower priority than all the UL signals and channels

Example 5: The method of example 1, wherein when a RedCap HD-FDD UE is expected to measure the DL PRS outside the measurement gap in a configured PRS processing window, depending on UE capability and configuration, and if the DL PRS is determined to be higher priority than the UL signals and channels inside the PRS processing window, those UL signals and channels are not expected to be transmitted by the UE.

Example 6: The method of example 1, wherein when a RedCap HD-FDD UE is expected to measure the DL PRS outside the measurement gap in a configured PRS processing window, depending on UE capability and configuration, if the DL PRS is determined to be higher priority than the UL signals and channels inside the PRS processing window, those UL signals and channels are not expected to be transmitted by the UE on the overlapped symbols with the DL PRS,

Example 7: The method of example 1, wherein when a RedCap HD-FDD UE is expected to measure the DL PRS outside the measurement gap in a configured PRS processing window, depending on UE capability and configuration, and if the DL PRS is determined to be higher priority than the PUSCH and PUCCH inside the PRS processing window, PUSCH and PUCCH are not expected to be transmitted by the UE.

Example 8: The method of example 1, wherein when a RedCap HD-FDD UE has an activated PRS processing window, depending on UE capability and configuration, and the UE determines the presence of other UL signals and channels of higher priority than the DL PRS in the PRS processing window no later than N2 symbols for the subcarrier spacing μ of the DL PRS or minimum subcarrier spacing between DL PRS and UL signals and channels, before the first symbol of the PRS processing window, the UE is expected to transmit the other UL signals and channels and may not be expected to receive DL PRS within the PRS processing window.

Example 9: The method of example 1, wherein when a RedCap HD-FDD UE has an activated PRS processing window, depending on UE capability and configuration, and the UE determines the presence of other UL signals and channels of higher priority than the DL PRS on a symbol configured with the DL PRS no later than N2 symbols for the subcarrier spacing μ of the DL PRS or minimum subcarrier spacing between DL PRS and UL signals and channels, before the DL PRS symbol, the UE is expected to transmit the other UL signals and channels and may not be expected to receive DL PRS in the affected symbol.

Example 10: The method of example 1, wherein when a RedCap HD-FDD UE has an activated PRS processing window, depending on UE capability and configuration, and the UE determines the presence of other UL signals and channels of higher priority than the DL PRS in the PRS processing window later than N2 symbols for the subcarrier spacing μ of the DL PRS or minimum subcarrier spacing between DL PRS and UL signals and channels, before the first symbol of the PRS processing window, the UE is not required to transmit the other UL signals and channels and may receive the DL PRS and consider the DL PRS as higher priority in the PRS processing window. Here, N2 is defined per UE processing capability 1 as in 3GPP TS 38.214.

Example 11: The method of example 1, wherein when a RedCap HD-FDD UE has an activated PRS processing window, depending on UE capability and configuration, and the UE determines the presence of other UL signals and channels of higher priority than the DL PRS on a symbol configured with the DL PRS later than N2 symbols for the subcarrier spacing μ of the DL PRS or minimum subcarrier spacing between DL PRS and UL signals and channels, before the DL PRS symbols, the UE is not required to transmit the other UL signals and channels and may receive the DL PRS symbol and consider the DL PRS as higher priority in that symbol. Here, N2 is defined per UE processing capability 1 as in 3GPP TS 38.214.

Example 12: The method of example 1, wherein for DL PRS with frequency hopping for a RedCap UE, the switching time or guard time between two DL PRS transmissions or receptions, the UE applies the same priority rules as defined in Clause 11.1 and Clause 17 in TS 38.213 and Clause 5.1.6.5 in TS38.214 during the switching time or guard period as if DL PRS is configured.

Example 13: The method of example 1, wherein RedCap UE in RRC INACTIVE mode is expected to prioritize the reception of any other DL signals and DL channels than the reception of DL PRS including any switching time or guard time for DL PRS with frequency hopping.

Example 14: The method of example 1, wherein for SRS for positioning with Tx frequency hopping for a RedCap UE, the switching period or guard time between two SRS transmissions or for the associated SRS transmission, the UE applies the same priority rules as defined in Clause 11.1 and Clause 17 in TS 38.213 and Clause 6.2.1 in TS 38.214 during the switching time or guard period as if SRS is configured or as for the associated SRS transmission.

Example 15: The method of example 1, wherein switching period may be defined before and/or after the associated SRS transmission(s) with frequency hopping.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus for a User Equipment (UE) having reduced capabilities (RedCap UE), the apparatus comprising: processing circuitry and memory, the processing circuitry configured to:
decode a radio resource control (RRC) information element (IE) comprising configuration information to configure the UE to perform transmit frequency hopping for sounding reference signal (SRS) positioning;
perform the transmit frequency hopping within an SRS resource with a bandwidth that is larger than a maximum bandwidth of the UE;
determine whether to drop an SRS transmission of the transmit frequency hopping based on priority rules when any one or more symbols of the SRS transmission would collide with an uplink channel transmission including a switching time for switching to or from an active bandwidth part; and
drop the one or more symbols of the SRS transmission that would collide with the uplink channel transmission including the switching time when the SRS transmission of the transmit frequency hopping is determined to be dropped.

2. The apparatus of claim 1, wherein the processing circuitry is to configure the UE to transmit symbols of the SRS transmission that do not collide with the uplink channel transmission including the switching time.

3. The apparatus of claim 1, wherein the UE is a half-duplex (HD) UE with reduced capacities that is not capable of simultaneous transmissions and receptions on a serving cell.

4. The apparatus of claim 3, wherein the UE has a maximum bandwidth of 20 MHz for frequency range one (FR1) and 100 MHz for frequency range 2 (FR2).

5. The apparatus of claim 4, wherein for the UE with the maximum bandwidth of 20 MHz for FR1, to perform the transmit frequency hopping within an SRS resource with a bandwidth that is larger than the maximum bandwidth of the UE, the processing circuitry is configured to transmit an SRS across multiple 20 MHz bandwidths to meet a larger bandwidth.

6. The apparatus of claim 4, wherein when any one or more symbols of the SRS transmission would collide with an uplink channel transmission including when any one or more symbols of the SRS transmission would collide with a switching time for switching to or from an active bandwidth part, and
wherein when the uplink channel transmission comprises a physical uplink control channel (PUCCH) with a priority index of one or a physical uplink shared channel (PUSCH) with a priority index of one, the processing circuitry is configured to is to drop the one or more symbols of the SRS transmission that would collide with the uplink channel transmission including the switching time.

7. The apparatus of claim 4, wherein when any one or more symbols of the SRS transmission would collide with an uplink channel transmission including when any one or more symbols of the SRS transmission would collide a switching time for switching to or from an active bandwidth part, and
wherein when the uplink channel transmission comprises a physical uplink shared channel (PUSCH) that does not have a priority index of one, the processing circuitry is to configure the UE to transmit the one or more symbols of the SRS transmission after transmission of the PUSCH.

8. The apparatus of claim 7, wherein to perform the transmit frequency hopping for SRS positioning, the processing circuitry is to configure the UE to transmit an SRS transmission for positioning outside an uplink bandwidth part of an uplink bandwidth part configuration of the UE.

9. The apparatus of claim 3, wherein the processing circuitry is further configured to decode the configuration information for prioritization of measurement reporting of a downlink positioning reference signal (DL PRS) with frequency hopping,
wherein a bandwidth of hops is configurable to be greater than the maximum bandwidth of the UE.

10. The apparatus of claim 9, wherein when the UE is to measure the DL PRS outside a measurement gap in a configured DL PRS processing window and when the DL PRS is determined to be higher priority than downlink signals and channels inside the configured DL PRS processing window based on the prioritization of measurement reporting, the processing circuitry is to configured to the UE to refrain from measuring the downlink signals and channels on symbols that overlap with the DL PRS.

11. The apparatus of claim 9, wherein when the UE is to measure the DL PRS outside a measurement gap in a configured DL PRS processing window and when the DL PRS is not determined to be higher priority than downlink signals and channels inside the configured DL PRS processing window based on the prioritization of measurement reporting, the processing circuitry is to configured to the UE to measure the downlink signals and channels on symbols that overlap with the DL PRS.

12. A non-transitory computer-readable storage medium that stores instructions for execution by processing circuitry of a User Equipment (UE) having reduced capabilities (RedCap UE), the processing circuitry configured to:
decode a radio resource control (RRC) information element (IE) comprising configuration information to configure the UE to perform transmit frequency hopping for sounding reference signal (SRS) positioning;
perform the transmit frequency hopping within an SRS resource with a bandwidth that is larger than a maximum bandwidth of the UE;
determine whether to drop an SRS transmission of the transmit frequency hopping based on priority rules when any one or more symbols of the SRS transmission would collide with an uplink channel transmission including a switching time for switching to or from an active bandwidth part; and
drop the one or more symbols of the SRS transmission that would collide with the uplink channel transmission including the switching time when the SRS transmission of the transmit frequency hopping is determined to be dropped.

13. The non-transitory computer-readable storage medium of claim 12, wherein the processing circuitry is to configure the UE to transmit symbols of the SRS transmission that do not collide with the uplink channel transmission including the switching time.

14. The non-transitory computer-readable storage medium of claim 12, wherein the UE is a half-duplex (HD) UE with reduced capacities that is not capable of simultaneous transmissions and receptions on a serving cell.

15. The non-transitory computer-readable storage medium of claim 14, wherein the UE has a maximum bandwidth of 20 MHz for frequency range one (FR1) and 100 MHz for frequency range 2 (FR2).

16. The non-transitory computer-readable storage medium of claim 15, wherein for the UE with the maximum bandwidth of 20 MHz for FR1, to perform the transmit frequency hopping within an SRS resource with a bandwidth that is larger than the maximum bandwidth of the UE, the processing circuitry is configured to transmit an SRS across multiple 20 MHz bandwidths to meet a larger bandwidth.

17. The non-transitory computer-readable storage medium of claim 15, wherein when any one or more symbols of the SRS transmission would collide with an uplink channel transmission including when any one or more symbols of the SRS transmission would collide with a switching time for switching to or from an active bandwidth part, and
wherein when the uplink channel transmission comprises a physical uplink control channel (PUCCH) with a priority index of one or a physical uplink shared channel (PUSCH) with a priority index of one, the processing circuitry is configured to is to drop the one or more symbols of the SRS transmission that would collide with the uplink channel transmission including the switching time.

18. The non-transitory computer-readable storage medium of claim 15, wherein when any one or more symbols of the SRS transmission would collide with an uplink channel transmission including when any one or more symbols of the SRS transmission would collide a switching time for switching to or from an active bandwidth part, and
wherein when the uplink channel transmission comprises a physical uplink shared channel (PUSCH) that does not have a priority index of one, the processing circuitry is to configure the UE to transmit the one or more symbols of the SRS transmission after transmission of the PUSCH.

19. The non-transitory computer-readable storage medium of claim 18, wherein to perform the transmit frequency hopping for SRS positioning, the processing circuitry is to configure the UE to transmit an SRS transmission for positioning outside an uplink bandwidth part of an uplink bandwidth part configuration of the UE.

20. A User Equipment (UE) comprising: processing circuitry and memory, the processing circuitry configured to:
decode a radio resource control (RRC) information element (IE) comprising configuration information to configure the UE to perform transmit frequency hopping for sounding reference signal (SRS) positioning;
perform the transmit frequency hopping within an SRS resource with a bandwidth that is larger than a maximum bandwidth of the UE;
determine whether to drop an SRS transmission of the transmit frequency hopping based on priority rules when any one or more symbols of the SRS transmission would collide with an uplink channel transmission including a switching time for switching to or from an active bandwidth part; and
drop the one or more symbols of the SRS transmission that would collide with the uplink channel transmission including the switching time when the SRS transmission of the transmit frequency hopping is determined to be dropped,
wherein the UE is a half-duplex (HD) UE with reduced capacities (RedCap UE) that is not capable of simultaneous transmissions and receptions on a serving cell.
